(19) United States
(12) Patent Application Publication
(10) Pub. No.: US 2009/0075241 A1
(43) Pub. Date: Mar. 19, 2009

(54) Apparatus and method for a directional receiver

(76) Inventor: Jimmy Ha, Taipo NT (HK)

Correspondence Address: MCDERMOTT WILL & EMERY LLP, 600 13TH STREET, N.W., WASHINGTON, DC, 20005-3096, US

(21) Appl. No.: 11/902,079

(22) Filed: Sep. 18, 2007

(51) Int. Cl. F41G 3/26; H01J 40/14

(52) U.S. Cl. 434/22; 250/215; 434/21

(57) ABSTRACT

A gun system including a gun directional receiver for directionally receiving a response light from a target emitter, wherein the response light includes an identification of the target emitter, and the gun system further including a gun emitter for broadly sending an identification light to a target receiver, wherein the identification light includes the target emitter identification.

### TECHNICAL FIELD

The present subject matter relates to methods and equipment for a system incorporating a directional infrared receiver. The present disclosure has particular applicability to gun systems and target systems.

### BACKGROUND

In recent years, various low cost gun and target systems have been developed incorporating directional infrared emitters. For example, a single gun may incorporate a directional infrared emitter which emits a tight infrared beam towards a target system with perhaps 6 infrared receivers. When a specific infrared receiver detects an infrared beam, some action is taken. For example, a specific mechanical actuator associated with the specific infrared receiver may mechanically eject a plastic bottle into the air. Alternatively, a red light may be activated, or an audio alarm may be triggered, or score may be kept.

These conventional gun and target systems typically have one infrared emitter per gun, and 6 or 10 infrared receivers in a target. One problem with conventional systems is infrared receivers are expensive in comparison to infrared emitters. Specifically, infrared receivers are about 10 times more expensive than infrared emitters.

Thus, conventional gun and target systems are relatively expensive because they have many infrared receivers.

Desired are gun systems and associated target systems that reduce costs by using few infrared receivers.

### SUMMARY

The teachings herein improve over conventional gun systems and conventional target systems by providing a gun system and an associated target system that can operate many targets using only two receivers (a gun receiver in the gun system, and a target receiver in the target system).

In one example, the gun system comprises a gun directional receiver, a gun circuit for information from the gun receiver; and a gun emitter for emitting an initiation light or an identification light. The gun directional receiver comprises a gun receiver and a gun aperture for receiving light only from a receiving direction.

In another example, the target system comprises a target emitter for sending a response light, a target receiver for receiving an initiation light or an identification light, and a target circuit.

Additional advantages and novel features will be set forth in part in the description which follows, and in part will become apparent to those skilled in the art upon examination of the following and the accompanying drawings or may be learned by production or operation of the examples. The advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a conventional gun system with a directional infrared emitter, and a conventional target system with three infrared receivers according to the prior art.

FIG. 2 is an exemplary gun system comprising a directional receiver according to the present disclosure.

FIG. 3 is an exemplary gun system and an exemplary target system illustrating an initiation of the target system according to the present disclosure.

FIG. 4 illustrates an exemplary response by the target system of the present disclosure.

FIG. 5 illustrates an exemplary identification by the gun system of the present disclosure.

FIG. 6 illustrates an exemplary alarm by the target system of the present disclosure.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The following emitters and receivers may be infrared emitters and infrared receivers. Further, the same configurations and logic apply to other types of radiation, and also apply to coherent radiation. The term “light” is used broadly throughout the specification and claims to include one or more of the following: infrared light, visible light, ultraviolet light, and other radiation, incoherent or coherent. The term “gun” is used broadly throughout the specification and claims, and is not limited to handheld devices that are manually pointed. Specifically, the term “gun” is defined as any system or machine with a directional emitter or a directional receiver. The term “target” is used broadly throughout the specification and claims, and is not limited to stationary objects. Specifically, the term “target” is defined as any system or machine that includes an emitter or a receiver. The term “aperture” is used broadly throughout the specification and claims as including one or more of an aperture or a collimator or optics configured to allow light to pass only along a certain direction.

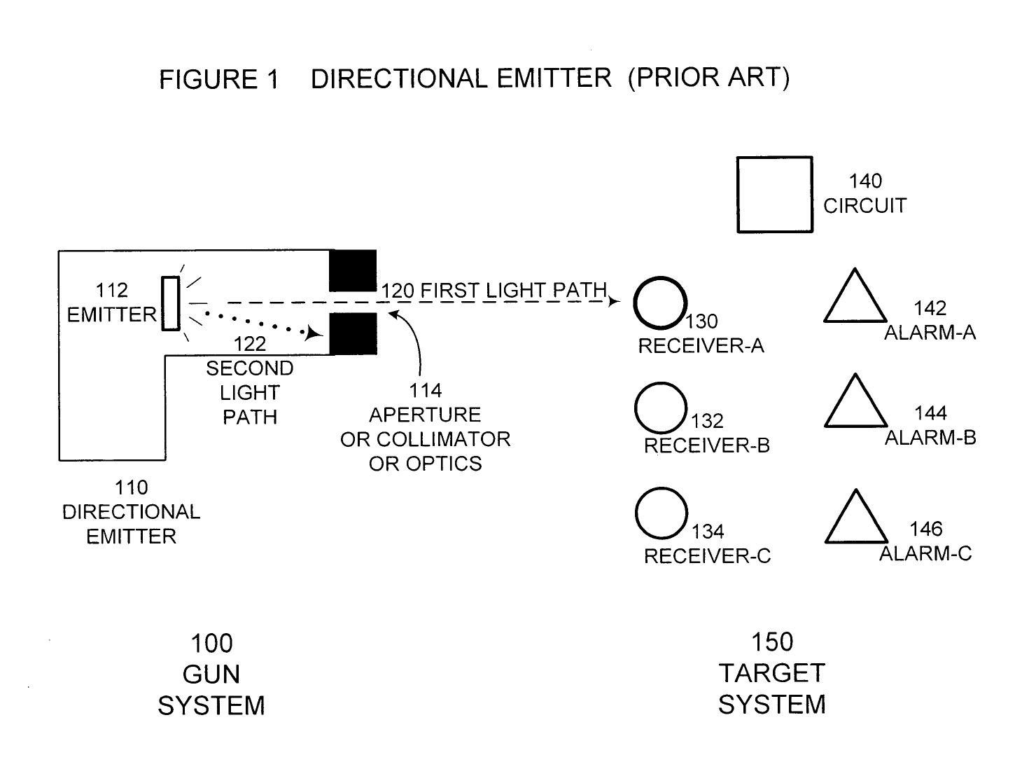

FIG. 1 shows a conventional gun system with a directional emitter, and a conventional target system with three receivers. The conventional gun system 100 typically comprises a directional emitter 110. The directional emitter 110 comprises an emitter 112 and an aperture or collimator or optics 114 which only permits a tight first light path 120 to exit the directional emitter 110. A second light path 122 from the emitter 112 cannot exit the directional emitter. Other conventional components such as a trigger, a battery, etc are omitted for the sake of clarity. The conventional target system 150 typically comprises one or more receivers (receiver-A 130, receiver-B 132, and receiver-C 134), a circuit 140, and one or more alarms (alarm-A 142, alarm-B 144, and alarm-C 146).

In a minimum conventional configuration, a single receiver such as receiver-A 130 may be optically aligned with the first light path 120 from the directional emitter 110. Upon receiving light (or infrared radiation, or other radiation) from the directional emitter, receiver-A 130 may perform some action such as alerting circuit 140 that a reception has occurred. Alternatively, receiver-A 130 may directly trigger an associated alarm such as alarm-A 142.

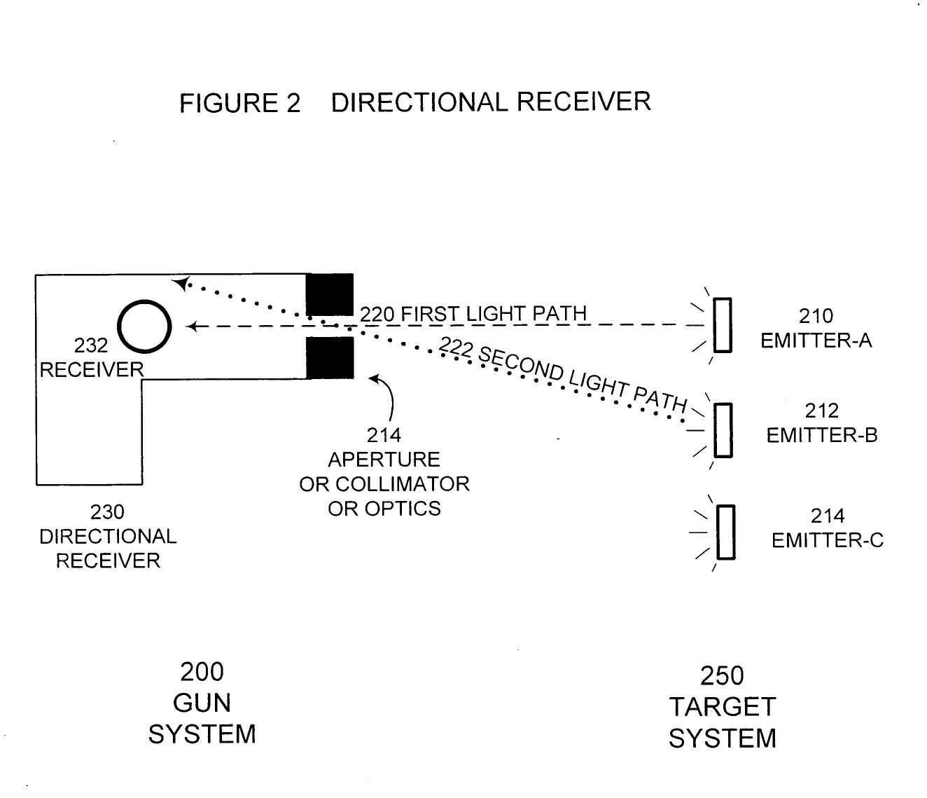

FIG. 2 is an exemplary gun system comprising a novel directional receiver. The directional receiver comprises an infrared receiver and an aperture or collimator or optics. Gun system 200 comprises a directional receiver 230. Directional receiver 230 comprises a receiver 232 and an aperture or collimator or optics 214. Aperture or collimator or optics 214 comprises one or more of an aperture, a collimator, and optics configured to allow first light path 220 to strike receiver 232, while preventing second light path 222 from emitter-B 212 from striking receiver 232. The term “aperture” is used broadly throughout the specification and claims as including one or more of an aperture or a collimator or optics configured to allow light to pass only along a certain direction relative to a directional receiver.

Note that gun system 200 is a directional receiver. This is the opposite of conventional gun system 100 from FIG. 1, in which gun system 100 is a directional emitter.

Target system 250 comprises one or more emitters (emitter-A 210, emitter-B 212, and emitter-C 214). This is the opposite of conventional target system 150 from FIG. 1, in which target system 150 included multiple receivers. In an example of a very simple gun system and target system, a single directional receiver 230 detects a single emitter-A 210 when the emitter-A 210 is properly aligned along the axis of the first light path 220. However, generally there are a large number of emitters.

In one example, Emitter-A 210 is a semiconductor device, and emits light approximately in a 180 degree cone, as illustrated by the small short lines emitting broadly from the left side of emitter-A 210. Emitter-A 210 introduces identification information into the emitted light by pulses or frequency modulation, or other well known communication methods. This identification information allows receiver 232 to identify the source of any received light. Further, this identification information allows the directional receiver to identify a known or associated emitter, and thus avoid false positives from other light sources such as the sun or a desk light. In the simplest case (a gun system with a single directional receiver, and a target system with a single emitter) identification information is not essential.

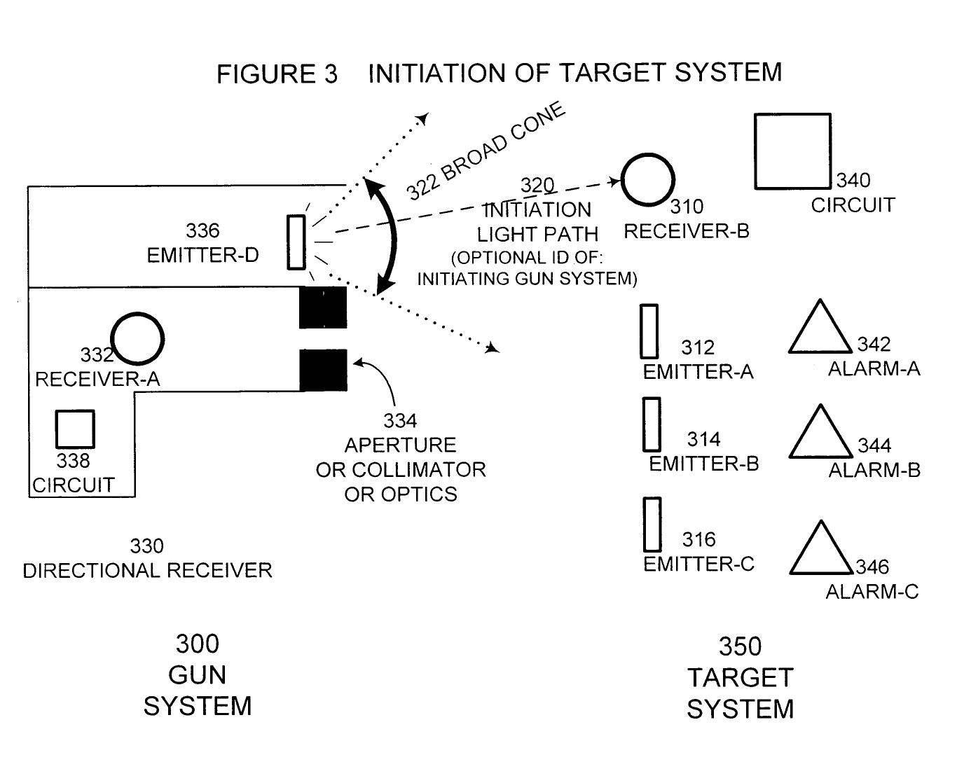

FIG. 3 is an exemplary gun system and an exemplary target system illustrating an initiation of the target system. The gun system comprises a directional receiver, a first circuit, and an emitter. The target system comprises a receiver, a second circuit, three emitters, and three alarms. Specifically, gun system 300 comprises a directional receiver 330 and an associated emitter 300. Directional receiver 330 comprises receiver-A 332, aperture 334, and first circuit 338. Again, some well known optional components such as a trigger, a battery, etc are omitted for the sake of clarity. Target system 350 comprises receiver-B 310, circuit 340, emitters (emitter-A 312, emitter-B 314, and emitter-C 316). In order to conserve energy (and possibly reduce the need for new batteries), in certain examples target system 350 remains in a dormant or sleep or ready state until initiation.

Gun system 300 attempts to initiate the target system by sending an initiation light along a broad cone 322 including initiation light path 320. This initiation may be constantly sent by the gun, or alternatively may only be sent when a gun trigger is pulled. If the gun system and target system delays are large, then it is preferable to constantly (or at regular intervals) emit the initiation light. However, if the system delays are small, then it is preferable to conserve target system energy by emitting the initiation light only upon pulling the trigger of the gun, or some similar command.

Target system 350 receives the initiating light at receiver-B 310. The initiating light initiates the target system, and the initiating may also include identification information regarding the gun system, so that the target may identify the gun system and also avoid false alerts from other light sources such as the sun, or a desk light, or a television controller. Receiver-B 310 will directly activate one or more emitters, or will notify second circuit 340 that an initiating light has been received and second circuit 340 will activate one or more emitters.

In some instances, the emitters that are activated are a function of the identity of the gun system 300. In other words, certain guns are restricted by second circuit 340 to “shooting at” (actually receiving light from) certain “targets” (certain emitters). For example, second circuit 340 only allows each target to be “shot” once by each gun system, until the target system is reset.

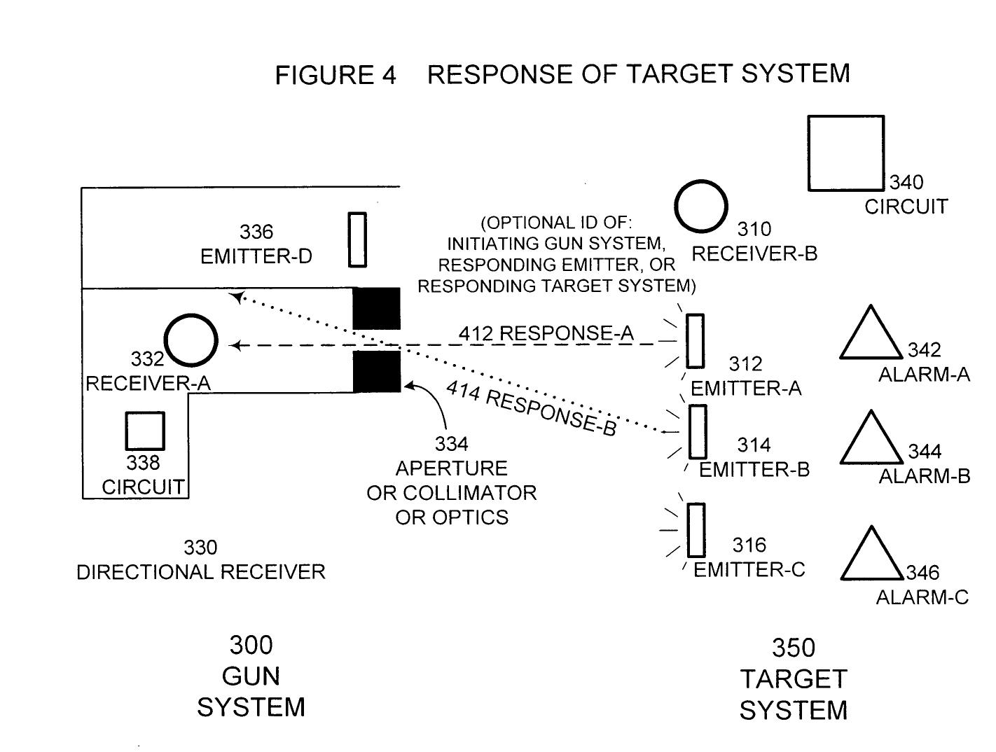

FIG. 4 illustrates an exemplary response by the target system. Target system 350 has initiated three emitters (emitter-A 312, emitter-B 314, and emitter-C 316). Each target system emitter (emitter-A 312, emitter-B 314, and emitter-C 316) responds to the initiation by emitting light in a broad beam, as indicated by the small lines emitting broadly to the left of each emitter. Each target emitter emits light containing information identifying the specific emitter, and/or information (previously received from the gun system in the initiation light) identifying which gun system has initiated the target system, and/or information identifying the specific target system.

As shown, emitter-A 312 is directionally aligned (or optically aligned, or in receiving direction) with directional receiver 330 so that light response-A 412 is received by receiver-A 332. Light response-B 414 from emitter-B 314 does not reach receiver-A 332. Receiver-A 332 receives light response-A 412 from directionally aligned emitter-A 312, and transmits information contained in light response-A to first circuit 338. This response information identifies the responding emitter, and/or identifies the gun system that initiated the target system, and/or identifies the responding target system. Receiver-A 332 transmits some or all of this information to first circuit 338. First circuit 338 stores and/or processes some or all of this response information from receiver-A 332, and then sends this response information to emitter-D 336. Further, first circuit 338 may block or screen responses that were not initiated by gun system 300.

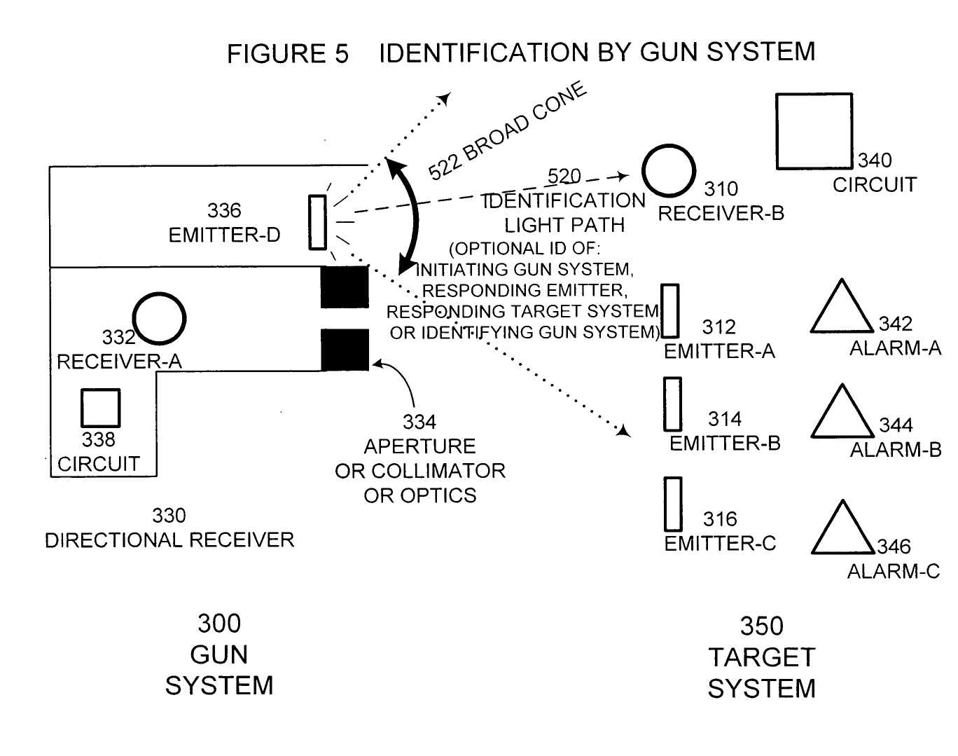

FIG. 5 illustrates an exemplary identification by the gun system. Emitter-D 336 emits light containing some or all of the response information: identification of the initiating gun system, identification of the responding target system, identification of the responding emitter, identification of the receiving/identifying gun system. In a multi-emitter target system (as shown), the identification light path 520 includes information identifying the target system emitter (emitter-A 312 in this example) which was received by the gun system receiver-A 332.

The light from emitter-D 336 is emitted in a broad cone 522, and reaches receiver-B310 which does not have to be in the optical path the directional receiver 330. Receiver-B 310 sends identification information from identification light path 520 to second circuit 340.

Second circuit 340 performs actions such as storing or displaying the identification information. If the identification information is associated with an emitter of target system 350, then second circuit 340 performs additional actions such as activating alarm-A 342, as shown by the dashed lines around alarm-A 342. Second circuit 340 may also perform more advanced operations such as using identification information to screen or block identifications associated with certain gun systems. Further, the number of “bullets” shot by a gun system (based on the number of initiations received as shown in FIG. 3) may be counted, and any excess “bullets” (beyond 6 bullets, for example) from a given gun system may be screened or blocked or ignored until some resetting occurs.

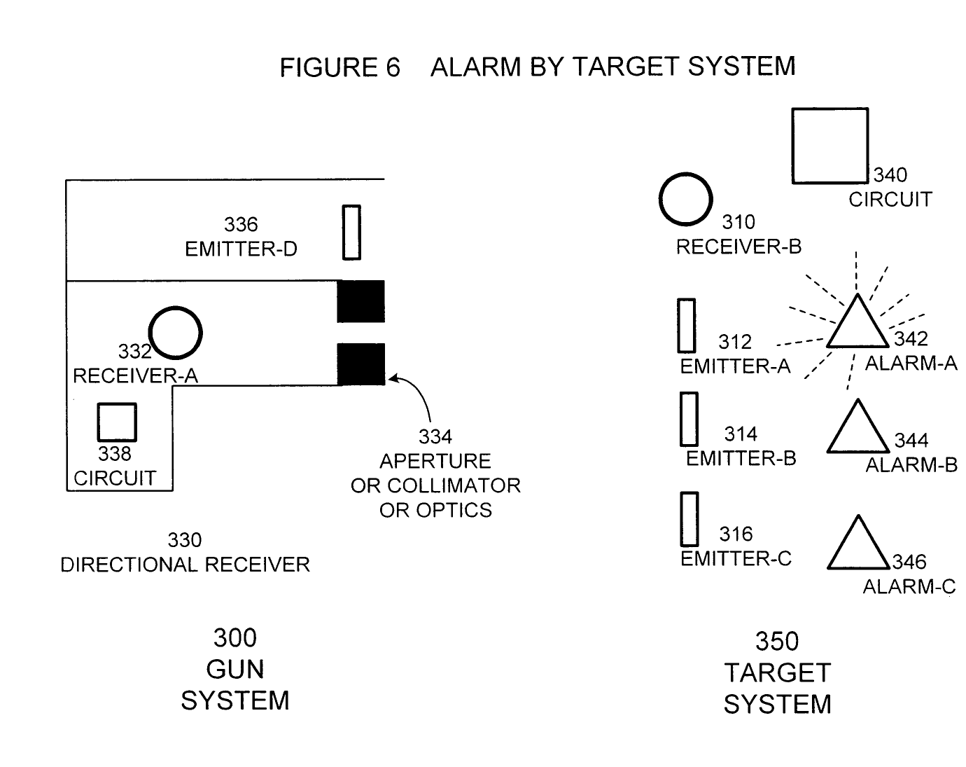

FIG. 6 illustrates an exemplary alarm by the target system. As discussed above regarding the identification in FIG. 5, receiver-B 310 has received an identification light from the gun system 300 that includes, at a minimum, information identifying either the emitter or the target system that emitted the response light. Receiver-B 310 transmits this information to second circuit 340.

Second circuit 340 then performs actions based upon the identification information from the identification light. For example, if the identification information identifies emitter-A 312, then alarm-A 342 is activated. Circuit 340 may perform additional functions such: increase a counter to keep track of the number of receptions or “hits” of the whole target system, or increase a counter to keep track of the number of “hits” of a specific target emitter, or identify the specific gun system which sent the identification, or identify the gun system which emitted the initiation light. Generally, second circuit 340 triggers one or more alarms (alarm-A 142, alarm-B 144, and alarm-C 146) which are associated with the emitter identified by the identification light.

Alarm-A 342 is visual alarm, and/or an audio alarm, and/or a mechanical alarm. An exemplary visual alarm is a flashing light emitting diode adjacent or surrounding the identified emitter (emitter-A 312). An exemplary audio alarm is a general audio alarm for all target system emitters which identifies the emitter by words (“target A has been hit”, or “ouch, you shot my leg”). An exemplary mechanical alarm is a mechanical device that turns a mechanical counter or ejects a spring-loaded plastic target bottle into the air (simulating a hit by a bullet). Similarly, target system 350 may have a single audio alarm, a single visual alarm, and multiple individual mechanical alarms. All combinations of audio, visual, and mechanical alarms are contemplated.

If desired, the circuit 340 will only allow each emitter to be “hit” once. Specifically, the activation of alarm-A 342 will disable the associated target emitter-A 312 for a fixed period of time, or until the target system is reset. In other words, a response by target system 350 will not emit a response from disabled emitter-A 312. Additionally or alternatively, an identification of emitter-A 312 by a gun system will not activate alarm-A 342 a second time, unless some period of time has passed or some resetting has occurred.

Second circuit 340 may keep “score” of parameters such as: which gun systems have hit which targets, and the number of “bullets fired” from each gun (initiations from each gun), and so forth. Different emitters of the target may be worth different amounts for points for scoring. For example, emitter-C 316 is mounted on a spinning device, and thus is harder to “hit” and worth more points, or emitter-B 314 is very small, and thus is harder to “hit” and worth more points.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A gun system comprising:
a gun directional receiver comprising a gun receiver and a gun aperture, wherein the gun aperture is configured transmit light from a receiving direction to the gun receiver, and the gun aperture is configured to block light which is not from the receiving direction;
a gun circuit configured to receive information from the gun receiver and send information to a gun emitter; and
the gun emitter is configured to emit an identification light including information received from the gun circuit.

2. The gun system of claim 1, wherein the gun circuit and gun emitter are configured to emit an initiation light.

3. The gun system of claim 1, wherein the gun receiver is configured to receive a response light from a target emitter of a target system.

4. The gun system of claim 3, wherein the response light includes information identifying the target emitter, or information identifying the target system, or information identifying the gun system that initiated the target system.

5. The gun system of claim 4, wherein the gun emitter is configured to broadly emit an identification light.

6. The gun system of claim 5, wherein the identification light includes information from the response light identifying the target emitter, or information identifying the target system, or information identifying the gun system that initiated the target system.

7. The gun system of claim 1, further comprising a gun body shaped approximately like a gun that shoots bullets, wherein the gun directional receiver is incorporated into a barrel of the gun body.

8. A target system comprising:
a target emitter for emitting a response light including a first identification information,
a target receiver for receiving an identification light including a second identification information, and
a target circuit in communication with the target receiver, wherein the target circuit is configured to receive the second identification information from the target receiver.

9. The target system of claim 8, wherein the target receiver is configured to receive an initiation light from a gun system.

10. The target system of claim 9, wherein the initiation light includes information identifying the gun system that sent the initiation light.

11. The target system of claim 9, wherein the target circuit is configured to respond to the initiation light by emitting a response light from the target emitter.

12. The target system of claim 11, wherein the response light from the target emitter includes information identifying the target emitter, or identifying the target system, or identifying the gun system that sent the initiation light.

13. The target system of claim 8, wherein the target receiver is configured to receive an identification light including identification information.

14. The target system of claim 13, wherein the identification information identifies the responding target emitter, or identifies the responding target system, or identifies the gun system that emitted the identification light, or identifies the gun system that initiated the target system.

15. The target system of claim 13, wherein the target circuit is configured to analyze the identification information in the identification light, and is configured to perform an action based on the identification information.

16. The target system of claim 15, wherein the identification information identifies a target emitter, and wherein the action is triggering an alarm associated with the identified target emitter.

17. The target system of claim 16, wherein the alarm is a light, or a speaker, or a mechanical device.

18. The target system of claim 17, wherein the mechanical device is a spring loaded plastic bottle configured for being ejected into the air when the alarm is triggered.

19. An interactive system comprising a gun system and a target system, wherein:
the gun system comprises:
a gun directional receiver comprising a gun receiver and a gun aperture, wherein the gun aperture is configured transmit light from a receiving direction to the gun receiver, and the gun aperture is configured to block light which is not from the receiving direction;
a gun circuit configured to receive information from the gun receiver and send information to a gun emitter; and
the gun emitter is configured to emit an identification light including information received from the gun circuit; and
the target system comprises:
a target emitter for emitting a response light including a first identification information; a target receiver for receiving an identification light including a second identification information; and a target circuit in communication with the target receiver, wherein the target circuit is configured to receive the second identification information from the target receiver.

20. The interactive system of claim 19, wherein the target system is configured to emit a response light in response to receiving an initiation light from the gun system.

21. The interactive system of claim 19, wherein the gun system is configured to emit an identification light in response to receiving a response light.

22. The interactive system of claim 19, wherein the target system is configured to perform an action upon receiving an identification light from the gun system, and wherein the action is triggering an alarm, and wherein the alarm is visual, audio, or mechanical.
